(19) United States
(12) Patent Application Publication
(10) Pub. No.: US 2007/0231544 A1
(43) Pub. Date: Oct. 4, 2007

(54) Process for the production of embossed films based on partially acetalized polyvinyl alcohol

(75) Inventor: Holger Stenzel, Hennef (DE)

Correspondence Address: MILLEN, WHITE, ZELANO & BRANIGAN, P.C., 2200 CLARENDON BLVD., SUITE 1400, ARLINGTON, VA, 22201, US

(73) Assignee: Kuraray Europe GmbH

(21) Appl. No.: 11/730,477

(22) Filed: Apr. 2, 2007

(30) Foreign Application Priority Data
Apr. 3, 2006 (EP) 06112163

(51) Int. Cl. B32B 17/10; B32B 27/16

(52) U.S. Cl. 428/141; 428/437; 428/524; 264/284

(57) ABSTRACT

The invention relates to a two-stage process for the production of a structured film based on partially acetalized polyvinyl alcohol with roughnesses of the surfaces, independently in each case, of R_{z}=20 to 80 μm by embossing the sides of the film between correspondingly roughened embossing rollers and pressing rollers with a certain Shore A hardness. The temperature of the film and the rollers is adjusted in order to fix the structure.

The invention relates to a process for the production of a film based on partially acetalized polyvinyl alcohol with a roughness of the surfaces set by two-stage embossing and to the use of the films for the production of composite glass laminates.

Composite safety glass panes consisting of two glass panes and one adhesive film which combines the glass panes and is based on partially acetalized polyvinyl alcohol, preferably of polyvinyl butyral (PVB), are used in particular as windscreens in motor vehicles, it being possible for a glass pane to be replaced, if necessary, by a polymer pane. In the construction sector, too, such silicate glass/silicate glass composites or silicate glass/polymer composites are used, e.g., as window panes or as intermediate walls, multiple composites, i.e. composites consisting of more than two supporting layers being used, if necessary and depending on their application, e.g. as bullet-proof glass.

### STATE OF THE ART

Plasticiser-containing films based on partially acetalized polyvinyl alcohol, in particular polyvinyl butyral (PVB) for the manufacture of safety composite glass are soft and tacky even at room temperature. Although the high tackiness is essential for holding the composite of glass/film/glass together in composite glass, the tackiness needs to be temporarily eliminated or, however, and at least suppressed, for transportation and the process of processing them to such glass. The inherent tackiness of the films can be reduced by a certain roughness.

Moreover, it needs to be possible for the air present between the film and the glass to be removed during processing of the film to form composite safety glass. In this respect, it is generally known to provide the films on one or both sides with a roughened surface. The air enclosed during the manufacture of the glass laminate is able to escape via the roughened surface such that a bubble-free laminate is obtained.

Usually, the roughness values of such an intermediate film, measured as R, according to DIN EN ISO 4287, are between 8 and 60 μm. A typical process for the manufacture of films with a roughened surface is known from EP 0 185 863 B1 as melt fracture process. Melt fracture processes lead to irregularly (stochastically) roughened surfaces.

Embossing processes are further processes described in the state of the art for the production of a roughened surface. The common feature of all film surfaces produced by embossing processes is a regular (non-stochastic) surface structure which exhibits good ventilation behavior particularly in the production process for glass laminates by the vacuum bag process, and consequently permits short process times and wide processing windows.

In comparison with melt fracture processes, embossing processes have the advantage that the regular surface structure obtained allows more rapid and simpler air removal during laminate production.

EP 0 741 640 B1 describes such an embossing process for the production of a surface embossed on both sides by means of two embossing rollers by means of which the film is provided with a regular line structure of the saw tooth type. The lines embossed on each side of the film cross each other at an angle of >25° such that a so-called moire pattern is prevented from forming in the composite glass, EP 1 233 007 A1 discloses an embossing process for avoiding the moire effect which process produces a regular liniform embossing structure on each side of the film. To avoid interferences, the line structures of the two film sides have different repetition frequencies.

Another process which is described in U.S. Pat. No. 5,972,280 uses only one roller to emboss the surface structure, instead of two embossing rollers, and a structured steel band fitting snugly to the roller via rolls and compressed air. The film is guided during the embossing process through the gap between the embossing roller and the steel band.

U.S. Pat. No. 4,671,913 discloses a process for embossing PVB films, the film being embossed in a single operating process between two structured rollers. The rollers—and consequently also the embossed film—have a roughness R_{z} of 10 to 60 μm.

The processes for embossing on both sides described above have the disadvantage that in the case of single stage embossing of both sides of the films, only a short residence time can be achieved in the roller gap. As a result, the embossing effect decreases strongly with an increasing embossing speed, which is undesirable for an industrial production process. Although it is possible to increase the residence time for one side of the film to be wound around an embossing roller such that this side of the film is in contact with the embossing roller longer than the other side, this reduces the accuracy of embossing and/or film sides with different embossing depths are obtained.

In the case of two-stage processes in which both sides of the film are embossed one after the other, this effect does not occur. However, in this case there is the risk that the embossed side of the film is levelled again or over embossed in the second embossing step. This can be suppressed by appropriately selecting the roller surface and the embossing pressure. Thus, US 2003/0022015, WO 01/72509, U.S. Pat. No. 6,077,374 and U.S. Pat. No. 6,093,4741 describe a single stage and two-stage embossing process for PVB films by means of embossing rollers of steel and pressing rollers with a rubber coating. The rubber coating and/or the force applied between the rollers onto the film is not described in any further detail. If the roller surfaces are too hard, this leads to a small embossing zone which, in practice, is reduced to one line. This leads to a lower residence time of the film in the embossing zone and consequently to a lower embossing speed. If, on the other hand, roller surfaces are used which are too soft, only an insufficient force can be applied onto the film such that the embossing quality decreases.

The existing processes merit improvement with respect to the embossing performance.

### SUMMAEY OF THE INVENTION

Thus, an aspect of the present invention is to develop a two-stage process for embossing films based, on partially acetalized polyvinyl alcohol, which process does not exhibit the above-mentioned disadvantages.

Upon further study of the specification and appended claims, further objects, aspects and advantages of this invention will become apparent to those skilled in the art.

Surprisingly enough, it has been found that embossing of a film based on acetalized polyvinyl alcohol of sufficient quality and with a sufficient speed between embossing rollers and pressing rollers of a certain Shore A hardness is possible.

Thus, the invention includes a process for embossing a film based on partially acetalized polyvinyl alcohol with roughnesses of the surfaces of, independently in each case, R_{z}=about 20 to 100 μm, preferably R_{z} of about 30 to 50 μm, the process comprising:
a. providing a film based on partially acetalized polyvinyl alcohol with a roughness of the surfaces of R_{z}=about 1 to 70 μm, preferably about 1 to 40 μm, in particular about 1 to 15 μm,
b. embossing a first surface of the film from a) between a correspondingly roughened embossing roller at a temperature of about 80 to 170° C. and a pressing roller at a temperature of about 0 to 60° C. to obtain a film with a roughness of the embossed surface of R_{z}=about 20 to 100 μm and
c. embossing the second surface of the film from b) between a correspondingly roughened embossing roller at a temperature of about 80 to 170° C. and a pressing roller at a temperature of about 0 to 60° C. to obtain a film with a roughness of the embossed surface of R_{z}=about 20 to 100 μm,
   the pressing rollers of both embossing stages having the same or a different Shore A hardness of about 50-80.

The entire disclosures of all applications, patents and publications, cited herein and of corresponding European application No. 06112163, filed Apr. 3, 2006, are incorporated by reference herein.

### BRIEF DESCRIPTION OF THE DRAWINGS

Various other features and attendant advantages of the present invention will be more fully appreciated as the same becomes better understood when considered in conjunction with the accompanying drawing wherein:

FIG. 1 illustrates the surface of the embossing zone between the embossing roller and the pressing roller;

FIG. 2 illustrates an embodiment according to the invention; and

FIG. 3 illustrates another embodiment according to the invention.

### DETAILED DESCRIPTION

Preferably, the process according to the invention leads to a non-stochastic roughness of the films. Measuring the surface roughness of the film with the roughness value R_{Z} is effected according to DIN EN ISO 4287 and DIN ISO 4288. The measuring devices used to measure the surface roughness must satisfy EN ISO 3274. The profile filters used must correspond to DIN EN ISO 11562.

The surface structure and/or roughness of the film according to step a) may be applied e.g. by the so-called flow or melt fracture process corresponding to EP 0 185 863 B1, the disclosure of which is hereby incorporated by reference. Different roughness levels can be produced by varying the width of the discharge gap and the temperature of the die lips directly on the die exit.

It is also possible to produce films by extrusion without melt fracture. Alternatively, the film can be produced by extrusion and smoothing over chilled rollers in line with U.S. Pat. No. 4,671,913, the disclosure of which is hereby incorporated by reference. The use of the films with as low a roughness as possible is preferred according to the process of the invention since rough structures can be over-embossed only with a greater embossing effort. Moreover, the original roughness may readjust itself during the production of the pre-composite such that the advantages of an embossed film compared with a surface roughened by melt fracture are reduced.

In the subsequent embossing processes according to steps b) and c), the film is provided on each side, independently in each case, with a surface structure and a roughness depth of R_{z}=about 20 to 100 μm, preferably R_{z}=about 20 to 80 μm, in particular R_{z}=about 30 μm to 50 μm.

The process according to the invention can be carried out in such a way that the sides of the structured film have different roughness depths R_{z}. This can be achieved e.g. by means of different tools or temperatures of the embossing tools and/or the pressing rollers.

Before and/or after embossing process b), and/or before and/or after embossing process c), the film can be cooled to about −10 to +20° C. to fix the surface structure of the film in this way. Cooling preferably takes place via correspondingly temperature-adjusted cooling rollers. In this case, so-called front cooling is possible, i.e. the side of the film embossed in process steps b) and/or c) is cooled. An alternative is so-called back cooling in the case of which the side of the film not embossed in process steps b) and/or c) is cooled.

Cooling of the films may also be restricted to their surface. Thus, the surface temperature of the embossed side of the film can be adjusted to about −10 to +20° C. before process step c). Alternatively, the non-embossed surface of the film can be adjusted to this temperature before steps b) and/or c).

Preferably, the embossing rollers are made of metal and possess a surface with a negative profile pattern of the structure present later on in the film surface. The embossing rollers used according to the process of the invention must have a roughness corresponding to the intended roughness of the film. In a process variation, the embossed film and the embossing rollers have the same or almost the same roughness. Depending on the process parameters of film temperature, line pressure, roller temperature, roller speed or film speed, the roughness of the embossed film may also be considerably lower than that of the embossing rollers. Thus, the roughness R_{z} of the embossing rollers may be 400%, preferably 300%, in particular 100% above the roughness R_{z} of the film surfaces embossed with this roller. The temperature of the embossing rollers is about 80 to 170° C., preferably about 100 to 150° C. and in particular about 110 to 140° C. Particularly preferably, the embossing rollers have a coated steel surface (e.g. PTFE) in order to reduce the adhesion of the film.

In the process according to the invention, the film is guided between the embossing roller and the pressing roller rotating in the opposite sense. Preferably, the film is exposed, between the embossing rollers and the pressing rollers of process steps b) and/or c) to a line pressure of about 20 to 80 N/mm, in particular about 40 to 65 N/mm. The line pressure can be the same or different in process steps b) and c). Line pressure should be understood to mean the pressing force of the roller pair based on the film width.

The pressing rollers have temperatures of about 0 to 60° C., preferably about 10 to 40° C., i.e. they are actively cooled vis-à-vis the embossing roller. The temperature of the pressing rollers may be the same or different in process steps b) and c).

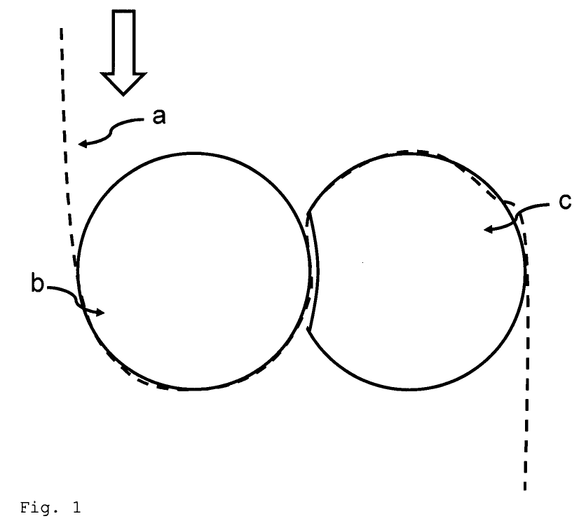

The pressing rollers have no or only a slight roughness (R_{z} maximum 10 μm) and preferably consist of a metal core with a surface of rubber or EPDM (ethylene-propylene diene elastomer). The surfaces of the pressing rollers, in particular, have a Shore A hardness of about 60 to 75. The pressing rollers press the film into the structured surface of the embossing rollers and nestle lightly against the embossing roller. By changing the line pressure, the surface of the embossing zone and consequently the residence time of the film in the roller gap can be altered. This is illustrated diagrammatically in FIG. 1, a) indicating the film to be embossed, b) the embossing roller and c) the pressing roller. Apart from the film being guided around the rollers, shown here, a simple manner of guiding the film through the roller gap without passing around the roller is possible.

By selecting the process parameters of line pressure, film temperature and/or roller temperature, roller speed and enveloping angle of the film web on the rollers, the roughness depth of the film embossing can be influenced with a given roughness depth of the embossing rollers.

The quality of the embossing process depends also on the constancy of the temperature of the film and consequently the chill, pressing and embossing rollers. Preferably, the temperature difference between the embossing and/or pressing rollers is consequently adjusted, over their width and circumference, to less than 2° C., in particular less than 1° C.

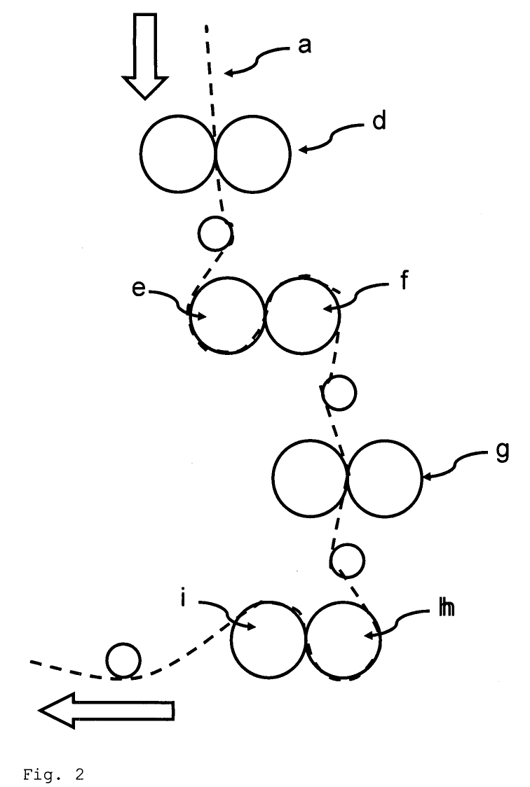

FIG. 2 shows diagrammatically a variation of the process according to the invention. The direction of travel of the film is indicated by double arrows. The film (a) which has been provided with a low roughness is optionally temperature-adjusted in the roller pair (d) and embossed on one side between the embossing roller (e) and the pressing roller (f). Rollers (e) and (f) are temperature-adjusted as described. Subsequently, the temperature of the film thus embossed on one side is adjusted in the roller pair (g). The second surface of the film is embossed by means of the again temperature-regulated embossing roller (h) and the pressing roller (i). The rollers not provided with a reference in FIG. 2 are used to guide the film. For a better temperature adjustment, the roller pairs (d) and (g) can also be surrounded by the film such that the residence time of the film on the rollers is increased.

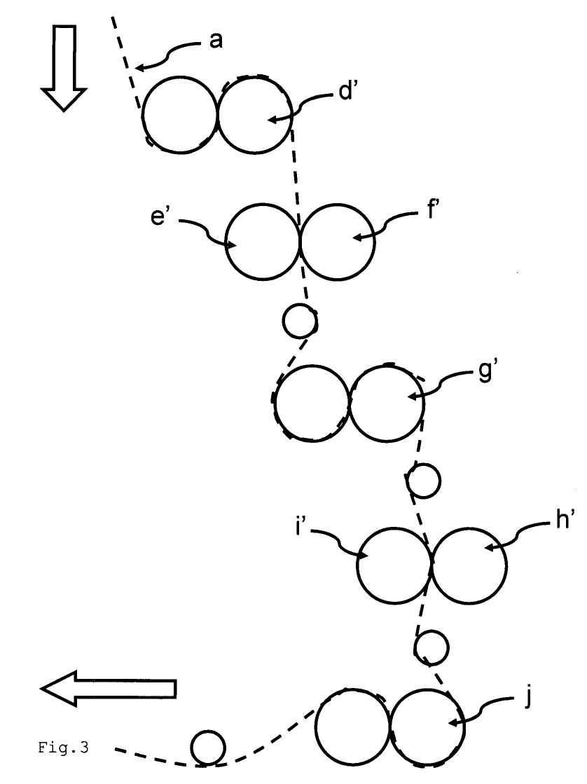

FIG. 3 shows a further variation of the process according to the invention. In this case, the film is (a) embossed, after optional temperature-adjustment, in roller pair d′ on one side between the embossing roller (e) and the pressing roller (f) and subsequently temperature-adjusted on one or both sides in the roller pair (g′). The second side of the film is subsequently embossed between the embossing roller (h′) and the pressing roller (i′). The surface structure is fixed by means of the chill rollers (j).

In this case, too, the film can be guided through the roller gap of the temperature-adjustment rollers directly, i.e., without passing around them.

It is possible to use in particular polyvinyl butyral (PVB), in the crosslinked or non-crosslinked form as partially acetalized polyvinyl alcohol, in mixture with at least one plasticiser, dyes, pigments, metal salts for adhesion regulation, organic additives and/or inorganic fillers.

All plasticisers known in the art for this purpose, in particular the esters of multivalent acids, polyhydric alcohols or oligoether glycols, such as, e.g., adipic acid esters, sebacic acid esters or phthalic acid esters, in particular di-n-hexyl adipate, dibutyl sebacate, dioctyl phthalate, esters of diglycol, triglycol or tetraglycol with linear or branched aliphatic carboxylic acids and mixtures of these esters are suitable, on the one hand, as plasticisers for the partially acetalized polyvinyl alcohols. Esters of aliphatic diols with long chain aliphatic carboxylic acids, in particular esters of triethylene glycol with aliphatic carboxylic acids containing 6 to 10 C. atoms, such as 2-ethyl butyric acid or n-heptanoic acid are preferably used as standard plasticisers for partially acetalized polyvinyl alcohols, in particular polyvinyl butyral. One or several plasticisers from the group consisting of di-n-hexyl adipate (DHA), dibutyl sebacate (DBS), dioctyl phthalate (DOP), esters of diglycol, triglycol or tetraglycol with linear or branched aliphatic carboxylic acids, in particular triethylene glycol-bis-2-ethyl butyrate (3GH), triethylene glycol-bis-n-heptanoate (3G7), triethylene glycol-bis-2-ethyl hexanoate (3G8), tetraethylene glycol-bis-n-heptanoate (4G7) are used particularly preferably.

In a particular embodiment of the present invention, the adhesion of the film to the embossing tools can be further reduced by adding one or more adhesion reducing substances to the film material. Generally, the total amount of adhesion reducing agents in the film material is about 0.0001-0.05 wt % (for example 0.01-2.0 wt %), preferably about 0.01-0.01 w t%.

For example, the adhesion reducing agents can be 0.01 to 2% by weight, based on the total mixture, of one or more pentaerythritol compounds according to formula I:

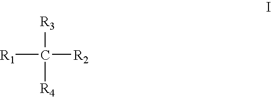

in which R₁, R₂, R₃, and R₄ are each, identically or differently, CH₂OH, CH₂OR₅, CH₂OCOR₅ or CH₂OCO—R₆—COOR₅, and R₅ and R₆ are each, independently, saturated or unsaturated, branched, or unbranched hydrocarbon radicals with 1 to 26 carbon atoms.

In the case of the use of partially acetalized polyvinyl alcohols as polymeric materials, the pentaerythritols or their esters used as an optional additive also facilitate the use of special plasticisers which, for example, have an improved sound deadening effect on the films, compare also DE 199 38 159 A1, the entire disclosure of which is hereby incorporated by reference. The special plasticisers include in particular the group of plasticisers consisting of
polyalkylene glycols of the general formula HO—(R—O)ₙ—H with R=alkylene and n>5,
block copolymers of ethylene glycol and propylene glycol of the general formula HO—(CH₂—CH₂—O)ₙ—(CH₂—CH(CH₃)—O)ₘ—H with n>2, m>3 and (n+m)<25,
derivatives of block copolymers of ethylene glycol and propylene glycol of the general formula R₁O—(CH₂—CH₂—O)ₙ—(CH₂—CH(CH₃)O)ₘ—H and/or HO—(CH₂—CH₂—O)ₘ—(CH₂—CH(CH₃)—O)ₘ—R₁ with n>2, m>3 and (n+m)<25 and R₁ as organic radical,
derivatives of polyalkylene glycols of the general formula R₁—O—(R₂—O)ₙ—H with R₂=alkylene and n≧2, in which the hydrogen of one of the two terminal hydroxy groups of the polyalkylene glycol is replaced by an organic radical R₁,
derivatives of polyalkylene glycols of the general formula R₁—O—(R₂—O)ₙ—R₃ with R₂=alkylene and n>5, in which the hydrogen of the two terminal hydroxy groups of the polyalkylene glycol is replaced by an organic radical R₁ or R₃.

In the case of partially acetalized polyvinyl alcohols, in particular PVB in this case, these special plasticisers are preferably used in combination with one or several standard plasticisers in a proportion of 0.1 to 15% by weight, based on the plasticisers. t

The plasticised partially acetalized polyvinyl alcohol resin preferably contains 25 to 45 parts by weight and particularly preferably 30 to 40 parts by weight of plasticiser, based on 100 parts by weight of resin.

The partially acetalized polyvinyl alcohols are produced in the known way by acetylation of hydrolysed polyvinyl esters. Formaldehyde, acetaldehyde, propionaldehyde, butyraldehyde and such like, preferably butyraldehyde, for example, are used as aldehydes.

The preferred polyvinyl butyral resin contains 10 to 25% by weight, preferably 17 to 23% by weight and particularly preferably 19 to 21% by weight of vinyl alcohol radicals and/or 0 to 20% by weight, preferably 0.5 to 2.5% by weight of acetate radicals.

In a further process variation, a PVB partially crosslinked with a polyaldehyde (in particular glutaraldehyde) and an oxocarboxylic acid (in particular glyoxylic acid) is used as polymer according to WO 2004/063231 A1. Such a partially crosslinked PVB has a viscosity which is 10 to 50% higher than that of the analogous non-crosslinked PVB.

The water content of the films is preferably adjusted to 0.15 to 0.8% by weight, in particular to 0.3 to 0.5% by weight.

The films produced according to the invention can be used in particular for the manufacture of laminates from one or several glass panes and/or one or several polymer panes and at least one structured film.

During the manufacture of these laminates, a pre-composite is first produced from the glass/polymer panes and the film by pressing, vacuum bag or vacuum lip. As a rule, pre-composite laminates are slightly turbid as a result of air inclusions. The final manufacture of the laminate takes place in the autoclave, e.g., according to WO 03/033583.

### EXAMPLE

A plasticizer-containing PVB film of 72.5% by weight PVB, 25% by weight 3G8 with potassium salts and magnesium salts as anti-adhesion agents with a roughness on both sides of Rz≦5 μm is embossed in a facility according to FIG. 3. The pressing and embossing rollers of the two embossing stages had identical properties.

Facility parameters:

| | |
|---|---|
| Embossing roller diameter: | 245 mm |
| Hardness of the rubber roller | 70 ± 5 Shore A |
| Diameter of the rubber roller: | 255 mm |
| Roughness of the embossing roller: | approximately 80 μm |
| Surface coating: | PTFE |

Films with the following embossing properties were obtained:

| | | | | T of | | |
|---|---|---|---|---|---|---|
| | | Line | T of | rubber | Rz (μm) | Rz (μm) |
| | Line speed | pressure | embossing | roller | upper | under- |
| No. | (m/min) | (N/mm) | roller (° C. | (° C.) | side | side |
| 1 | 1.34 | 32 | 100 | 10 | 30 | 32 |
| 2 | 1.42 | 48 | 100 | 10 | 45 | 45 |
| 3 | 2.3 | 50 | 110 | 10 | 40 | 40 |
| 4 | 2.75 | 40 | 110 | 10 | 48 | 38 |
| 5 | 6.0 | 60 | 110 | 10 | 38 | 44 |

In order to achieve identical roughnesses on both film sides it may be necessary to use different parameters in the two embossing stages, as illustrated in the following example:

| | | Line | T of | T of | | |
|---|---|---|---|---|---|---|
| | Line | pressure | embossing | rubber | Rz (μm) | Rz (μm) |
| | speed | (N/mm) | roller (° C.) | roller | upper | under- |
| No. | (m/min) | up.s (und.s) | up.s (und.s) | (° C.) | side | side |
| 6 | 2.3 | 70 (80) | 120 (125) | 10 | 90 | 90 |

During the manufacture of the composite glass, the films exhibited good air removal properties and could be processed to blister-free laminates.

### Comparative Example

Instead of rubber rollers with the Shore A hardness according to the invention, steel rollers were used.

Even when using two coated embossing rollers, the film tends to stick to one of the rollers since no defined take-off point is present. Moreover, the film becomes smooth on one side at speeds of approx. 3 m/min and more since the residence time in the embossing gap is too short.

No films usable for the manufacture of composite glass were obtained and such a process is unsuitable for industrial purposes.

The preceding examples can be repeated with similar success by substituting the generically or specifically described reactants and/or operating conditions of this invention for those used in the preceding examples.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

From the foregoing description, one skilled in the art can easily ascertain the essential characteristics of this invention and, without departing from the spirit and scope thereof, can make various changes and modifications of the invention to adapt it to various usages and conditions.

1. A process for embossing a film based on partially acetalized polyvinyl alcohol, said process comprising:
a. providing a film based on partially acetalized polyvinyl alcohol, wherein each of the surfaces of the film has a roughness, R_{z}, of 1 to 70 μm;
b. embossing a first surface of said film from a) between a correspondingly roughened first embossing roller at a temperature of 80 to 170° C. and a first pressing roller at a temperature of 0 to 60° C. to obtain a film in which said first surface is embossed and has a roughness, R_{z}, of 20 to 100 μm; and
c. embossing the second surface of said film from b) between a correspondingly roughened second embossing roller at a temperature of 80 to 170° C. and a second pressing roller at a temperature of 0 to 60° C. to obtain a film in which said second surface is embossed and has a roughness, R_{z}, of 20 to 100 μm;
wherein said first and second pressing rollers each, independently, have a Shore A hardness of 50-80.

2. A process according to claim 1, wherein said film is exposed to a line pressure of 20 to 80 N/mm between said first embossing roller and said first pressing roller, and between said second embossing roller and said second pressing roller.

3. A process according to claim 1, wherein each said pressing rollers has a rubber or EPDM surface.

4. A process according to claim 1, wherein the temperature difference of said embossing rollers is less than 2° C. across their width and their circumference.

5. A process according to claim 1, wherein the temperature difference of said pressing rollers is less than 2° C. across their width and their circumference.

6. A process according to claim 1, wherein each embossed surface of the embossed film, independently, has a roughness R_{z} of 20 to 80 μm.

7. A process according to claim 1, wherein the temperature of the film is adjusted to −10 to +20° C. before and/or after b), and/or before and/or after c).

8. A process according to claim 1, wherein the surface of the film embossed in b) is cooled, the surface of the film embossed in c) is cooled, or the surface of the film embossed in b) and the surface of the film embossed in c) are cooled.

9. A process according to claim 1, wherein the surface of the film not embossed in b) is cooled, the surface of the film not embossed in c) is cooled, or the surface of the film not embossed in b) is cooled and the surface of the film not embossed in c) is cooled.

10. A process according to claim 1, wherein each embossed surface of the embossed film, independently, has a roughness R_{z} of 30 to 50 μm.

11. A process according to claim 1, wherein each of the surfaces of the film provided in a) has a roughness, R_{z}, of 1 to 15 μm.

12. A process according to claim 1, wherein the temperature of said first embossing roller is 100 to 150° C., and the temperature of said second embossing roller is 100 to 150° C.

13. A process according to claim 1, wherein the temperature of said first embossing roller is 110 to 140° C., and the temperature of said second embossing roller is 110 to 140° C.

14. A process according to claim 1, wherein said film is exposed to a line pressure of 40 to 65 N/mm between said first embossing roller and said first pressing roller, and between said second embossing roller and said second pressing roller.

15. A process according to claim 1, wherein the temperature of said first pressing roller is 10 to 40° C., and the temperature of said second pressing roller is 10 to 40° C.

16. A process according to claim 1, wherein said first and second pressing rollers each, independently, have a Shore A hardness of 60 to 75.

17. A process according to claim 1, wherein said film contains at least one reducing adhesion substance to reduce the adhesion of the film to the embossing rollers.

18. A process according to claim 17, wherein said at least one reducing adhesion substance is a pentaerythritol compound according to formula I: 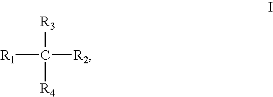
wherein
R₁, R₂, R₃, and R₄ are each, identically or differently, CH₂OH, CH₂OR₅, CH₂OCOR₅ or CH₂OCO—R₆—COOR₅, and R₅ and R₆ are each, independently, saturated or unsaturated, branched, or unbranched hydrocarbon radicals with 1 to 26 carbon atoms.

19. A process according to claim 17, wherein said the amount of adhesion reducing substance in said film is 0.01 to 2% by weight, based on the total mixture of the film.

20. A process according to claim 1, wherein said film based on partially acetalized polyvinyl alcohol is a film based on partially acetalized polyvinyl butyral.

21. A laminate comprising:
at least one glass pane, at least one polymer pane, or at least one glass pane and at least one polymer pane; and
at least one structured film produced according to the process of claim 1.
